(19) United States
(12) Patent Application Publication
(10) Pub. No.: US 2008/0223458 A1
(43) Pub. Date: Sep. 18, 2008

(54) TANK VENT PALLET

(76) Inventor: Robert C. Rajewski, Stettler (CA)

Correspondence Address: HOLLAND LAW OFFICE P.L.L.C., P.O. BOX 1840, BOISE, ID, 83701-1840, US

(21) Appl. No.: 11/743,252

(22) Filed: May 2, 2007

(30) Foreign Application Priority Data
Mar. 16, 2007 (CA) 2,582,631

(51) Int. Cl. F16K 17/19

(52) U.S. Cl. 137/528

(57) ABSTRACT

A breather valve comprises a valve body having a valve fluid passageway terminating in a valve seat. The valve body includes a pressure pallet guide and the valve seat has double lips. A pressure pallet having a size commensurate with the valve seat is mounted on the pressure pallet guide for limited motion towards and away from the valve seat. The pressure pallet has a sealing side oriented to face the valve seat. A flexible diaphragm extending inside the valve seat is secured to the sealing side of the pressure pallet outside the valve seat. A gap lies between the double lips of the valve seat. A liquid source is in fluid communication with the gap lying between the double lips of the valve seat. A liquid seal provides protection against freezing, gumming and leaking of the seal.

### BACKGROUND

This patent document relates to a breather valve with a liquid seal. U.S. Pat. No. 5,819,793, patented on Oct. 13, 1998, describes a breather valve, which, like other breather valves of which the inventor is aware, does not provide a seal that is leak proof. Industry standards allow for a limited leak rate for breather valves. A slight leak will often occur between a valve pallet and a valve seat of a breather valve particularly in freezing conditions. There is a need for a breather valve that has a seal that is more resistant to effects of freezing. There is also a need for a breather valve with a seal that is resistant to gumming. There is a need for a breather valve that provides a more effective seal.

### SUMMARY

In an embodiment there is a breather valve comprising a valve body having a valve fluid passageway terminating in a valve seat. The valve body includes a pressure pallet guide and the valve seat has double lips. A pressure pallet, having a size commensurate with the valve seat, is mounted on the pressure pallet guide for limited motion towards and away from the valve seat. The pressure pallet has a sealing side oriented to face the valve seat. A flexible diaphragm, extending inside the valve seat, is secured to the sealing side of the pressure pallet outside the valve seat. The valve seat is sealed to the flexible diaphragm with a liquid seal.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a side view of an embodiment of a breather valve having a liquid seal; and

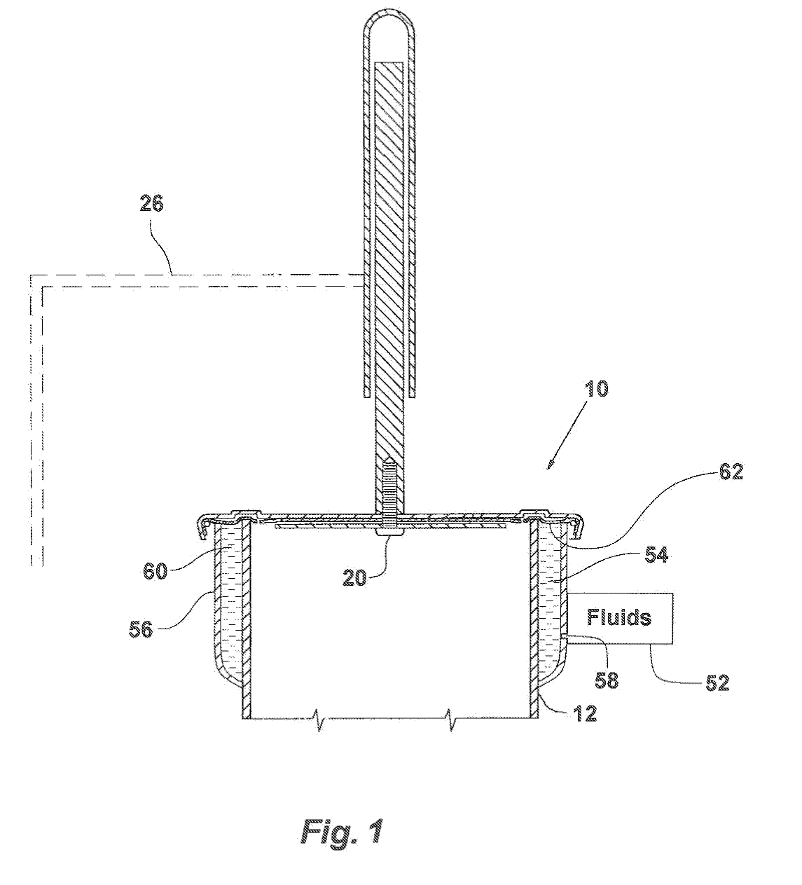

FIG. 2 is an enlarged side view of a valve seat and pressure pallet of the embodiment of FIG. 1.

### DETAILED DESCRIPTION

In the claims, the work “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

Referring to the figures, a breather valve 10 is formed from a valve body 12 having a valve fluid passageway 14 terminating in a valve seat 16. The valve 10 will have other conventional structural parts, as is well known to a person in the art, but which do not need to be described here.

A pressure pallet 18 is mounted closely adjacent the valve seat 16 for limited motion towards and away from the valve seat 16. For this purpose, the pressure pallet 18 is secured, as for example by screw 20, to a guide post 22. The guide post 22 in turn is received by a guide channel 24 which forms part of the valve body 12 as represented at 26. The guide post 22 and the guide channel 24 taken together are components of a pressure pallet guide. The pressure pallet 18 is free to move until it is prevented from movement downward towards the valve seat 16 by contact with the valve seat 16. Conventionally, the guide post 22 is mounted vertically, with the force moving the pressure pallet 18 towards the valve seat 16 being supplied by gravity, but the guide post 22 may be horizontal or have other orientations with the force, if not supplied by gravity, supplied by a spring or like means.

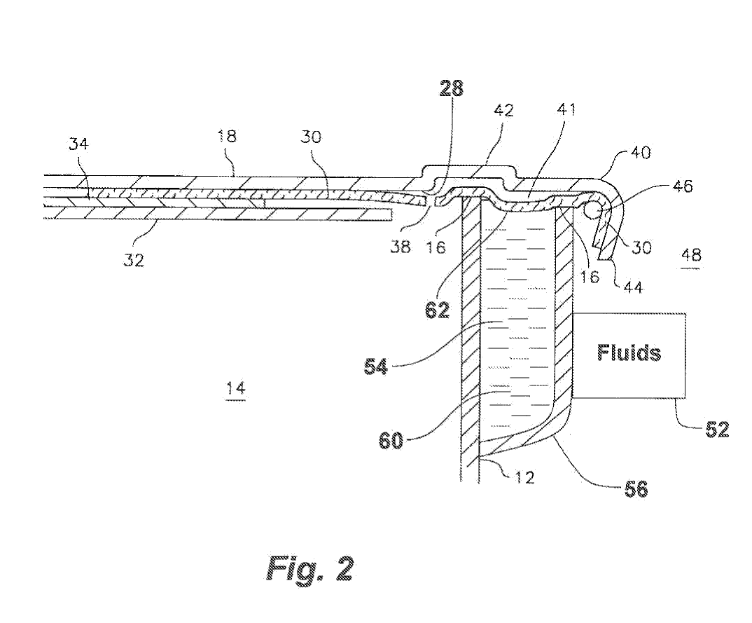

The pressure pallet 18 has a size commensurate with the valve seat 16, such that the pressure pallet 18 is large enough to cover the valve fluid passageway 14 and extend beyond the valve seat 16 sufficiently for the purposes of this embodiment. The pressure pallet 18 has a sealing side 28 shown in FIG. 2 oriented to face the valve seat 16.

A flexible diaphragm 30 is secured to the sealing side 28 of the pressure pallet 18. The flexible diaphragm 30 is circular and has a central opening for receiving screw 20. Inside the valve seat 16, that is, within the valve fluid passageway 14, the flexible diaphragm 30 is preferably secured to the pressure pallet 18 by pressure from a plate 32 which also has a central opening for receiving screw 20. Securing the flexible diaphragm 30 in this manner prevents it from flapping during high flow rates of fluid through the breather valve. The flexible diaphragm 30 is squeezed between the plate 32 and the pressure pallet 18. A gasket 34 is located between the plate 32 and diaphragm 18. The plate 32 extends across the pressure pallet 18 close to the valve seat 16 to secure the flexible diaphragm 30 against the pressure pallet 18 around a first circumference inside the valve seat 16, which circumference coincides with the outer edge of the plate 32. The flexible diaphragm 30 has holes 38 to allow fluid to exit from the valve fluid passageway 14 past the diaphragm 18 into the space between the diaphragm 18 and the pressure pallet 18. The holes 38 render the flexible diaphragm fluid pervious on the inside of the valve seat 16 and may be located anywhere on the inside of the valve seat 16 between the valve seat 16 and the plate 32, or even inside of the edge of the plate 32 if the plate 32 is slotted. However, placing slots in the plate 32 requires alignment of the slots over the holes in the diaphragm and so is not preferred.

The flexible diaphragm 30 extends outward to the outer periphery 40 of the pressure pallet 18, and is secured to the pressure pallet 18 at the periphery 40, which forms a second circumference outside the valve seat 16. Between the plate 32 and the periphery 40, the flexible diaphragm 30 is not secured to the pressure pallet 18 and thus is separated from the sealing side 28 of the pressure pallet 18 between the plate 32 and the periphery 40. Separation of the flexible diaphragm 30 over this region creates an annular cushion 41 over the valve seat 16. In the region between the valve seat 16 and the periphery 40 of the pressure pallet 18, namely outside of the valve seat, the flexible diaphragm 30 is fluid impervious. Preferably, the flexible diaphragm 30 is fluid impervious everywhere except at a few selected points (the holes 38) inside the valve seat 16.

For low pressure operations, the pressure pallet 18 may include an annular indentation 42 extending around the pressure pallet 18.

In the embodiment shown, the flexible diaphragm 30 is secured to the pressure pallet 18 by the following mechanism. The pressure pallet 18 has a depending inwardly directed flange 44 forming the outer periphery 40 of the valve seat 16. The flange 44 thus forms, with the main portion of pressure pallet 18, an acute angle facing inward. A resilient ring 46 is held within the angle by being dimensioned such that it makes a close fit with the inner edge of the angle when the flexible diaphragm 30 is not installed. When the flexible diaphragm 30 is installed, the ring 46 compresses the flexible diaphragm 30 against the angle formed by the flange 44. The flexible diaphragm 30 is preferably secured directly to the sealing side 28 of the pressure pallet 18 along the inner circumference and along the inner circumference, without intervening material.

The valve seat 16 has double lips that the flexible diaphragm 30 seats on. A pair of gapped, spaced-apart walls defines the double lips. In the embodiment shown the gapped, spaced-apart walls comprise a portion of valve body 12 and a valve seat wall 56. The valve seat wall 56 is attached to the exterior of the valve body 12. A gap 54 lies between the gapped, spaced-apart walls of the valve seat 16. Chemicals, liquids or fluids 60 are injected between the double lips so that the gap 54 between the double lips is filled with liquid 60. The flexible diaphragm 30 is pushed down against the liquid 60 to create a liquid seal 62.

In the embodiments shown, a liquid source 52 is in fluid communication with gap 54. The gap 54 lies between the valve seat wall 56 and the valve body 12. An inlet 58 connects the liquid source 52 to the gap 54. The gap 54 defines a liquid annulus that lies exterior to the valve body 12.

In operation, liquid 60 is injected into the gap 54 from the liquid source 52. The liquid 60 fills the gap 54 to create a liquid seal 62 between the valve seat and the flexible diaphragm 30. When the valve is in a closed position, the flexible diaphragm 30 may rest on the liquid 60 that lies within the liquid annulus 54. The liquid seal 62 is maintained by keeping the gap 54 full of liquid 60. The liquid seal 62 provides a continuous seal between the double lips of the valve seat and the adjacent section of the flexible diaphragm. When a positive pressure differential arises between the valve fluid passageway 14 and the area 48 outside of the fluid passageway 14, the fluid enters the fluid cushion 41 though holes 38. This fluid presses the flexible diaphragm 30 against the valve seat 16. As the flexible diaphragm 30 is pushed against the valve seat 16, the liquid seal 62 between the flexible diaphragm 30 and the valve seat 16 prevent fluid from escaping from the valve fluid passageway 14 of the breather valve 10. The pressure differential may be formed by an increase in pressure in the area 14 or a vacuum condition in the area 48. In either instance, the pressure between the flexible diaphragm 30 and the pressure pallet 18 rapidly rises evenly around the fluid cushion 41 to cause an even positive seal around the valve seat 16. The continuous contact between the flexible diaphragm 30 and the liquid seal 62 reduces the possibilities of leaks between the valve seat 16 and the flexible diaphragm 30. In the case of extreme pressure differential, when the breather valve 10 releases fluid from the valve fluid passageway 14 to the area 48 outside of the fluid passageway 14, some of the liquid 60 in the gap 54 may evaporate or be expelled from the gap 54. In this case, the liquid 60 in the gap 54 may need to be replenished from the liquid source 52 to refill the gap 54 and to provide the liquid seal 62.

In an embodiment, the liquid source is a methanol source, which may be any suitable source of methanol. In alternative embodiments, the gap 54 may lie on the interior of the valve body 12. In an embodiment the liquid seal 62 between the gap 54 and the flexible diaphragm 30 prevents freezing, wax build-up or other solidifying problems around the valve seat 16, flexible diaphragm 30 and pressure pallet 18.

Immaterial modifications may be made to the embodiments described here without departing from what is covered by the claims.

What is claimed is:

1. A breather valve comprising:
a valve body having a valve fluid passageway terminating in a valve seat, the valve body including a pressure pallet guide and the valve seat having double lips;
a pressure pallet having a size commensurate with the valve seat, the pressure pallet having a sealing side oriented to face the valve seat, the pressure pallet being mounted on the pressure pallet guide for limited motion towards and away from the valve seat;
a flexible diaphragm secured to the sealing side of the pressure pallet outside the valve seat, the flexible diaphragm extending inside the valve seat; and
in which the valve seat is sealed to the flexible diaphragm with a liquid seal.

2. The breather valve of claim 1 in which the flexible diaphragm extends inside the valve seat, and is separated from the sealing side over the valve seat to create an annular cushion over the valve seat, whereby upon creation of a pressure differential between the inside and outside of the valve body pressure within the annular cushion forces the flexible diaphragm against the valve seat.

3. The breather valve of claim 1 in which a gap lies between the double lips of the valve seat, the gap being filled with liquid to provide the liquid seal.

4. The breather valve of claim 3 in which the gap is in the shape of an annulus.

5. The breather valve of claim 3 in which a liquid source is connected to provide liquid to the gap.
